(19) United States
(12) Patent Application Publication
(10) Pub. No.: US 2020/0290829 A1
(43) Pub. Date: Sep. 17, 2020

(54) SHEET FEEDING DEVICE AND IMAGE FORMING APPARATUS INCORPORATING THE SHEET FEEDING DEVICE

(71) Applicants: Jumpei AOYAMA, Kanagawa (JP); Hirofumi HORITA, Kanagawa (JP)

(72) Inventors: Jumpei AOYAMA, Kanagawa (JP); Hirofumi HORITA, Kanagawa (JP)

(73) Assignee: Ricoh Company, Ltd, Tokyo (JP)

(21) Appl. No.: 16/801,412

(22) Filed: Feb. 26, 2020

(30) Foreign Application Priority Data
Mar. 11, 2019 (JP) 2019-043919

(51) Int. Cl. B65H 3/46; B65H 3/06; B65H 5/06; G03G 15/00

(52) U.S. Cl. CPC B65H 3/46; B65H 3/0684; B65H 2405/30; G03G 15/6511; B65H 5/06

(57) ABSTRACT

A sheet feeding device includes a sheet feeding body, a sheet separating body, a loading body, a support, and a pressing body. The sheet feeding body is configured to feed a recording sheet. The sheet separating body is configured to separate the recording medium and convey the recording medium together with the sheet feeding body. The loading body is configured to load the recording medium to be fed by the sheet feeding body. The support is disposed above the sheet separating body. The pressing body is made of metal and rotatably supported by the support between the loading body and the sheet separating body. The pressing body includes a part-shaped face to contact or face the recording medium. A surface of the part is covered with a metal plating.

### CROSS-REFERENCE TO RELATED APPLICATION

This patent application is based on and claims priority pursuant to 35 U.S.C. § 119(a) to Japanese Patent Application No. 2019-043919, filed on Mar. 11, 2019, in the Japan Patent Office, the entire disclosure of which is hereby incorporated by reference herein.

### BACKGROUND

### Technical Field

This disclosure relates to a sheet feeding device and an image forming apparatus incorporating the sheet feeding device.

### Background Art

Various types of sheet feeding devices are known to include a sheet metal part (also referred to as a metal plate in the Background Art section) processed with a metallic pressure plate that functions as a pressing body, in addition to a sheet separation roller that functions as a sheet separating body, for the purpose of separating and conveying a sheet that functions as a recording medium.

The metal plate is used for pressure application before sheet separation, that is, a sheet separation method in which pressure is applied before sheet separation is performed by the sheet separation roller even when additional sheets are supplied, so that multi-sheet feeding failure is prevented. With pressure application before sheet separation using such a metal plate, a tip of the metal plate that contacts a sheet feed roller or a sheet is bent into an R-shaped curve, so that the following inconveniences are prevented.

To be more specific, the above-described bending process of the edge of the metal plate is known to prevent (1) deviation of contact to a sheet feed roller by increasing the rigidity of the bent portion of the metal plate due to plastic deformation of the metal plate, (2) loss of safety and easy wear of the sheet feed roller with a sharp tip of the metal plate, and (3) scraping of sheet and generation of paper dust caused by contact with the sharp tip of the metal plate.

### SUMMARY

At least one aspect of this disclosure provides a novel sheet feeding device including a sheet feeding body, a sheet separating body, a loading body, a support, and a pressing body. The sheet feeding body is configured to feed a recording sheet. The sheet separating body is configured to separate the recording medium and convey the recording medium together with the sheet feeding body. The loading body is configured to load the recording medium to be fed by the sheet feeding body. The support is disposed above the sheet separating body. The pressing body is made of metal and rotatably supported by the support between the loading body and the sheet separating body. The pressing body is configured to contact and separate with respect to the sheet feeding body at an edge of the pressing body. The pressing body includes a part-shaped face to contact or face the recording medium. A surface of the part is covered with a metal plating.

Further, at least one aspect of this disclosure provides an improved image forming apparatus including an image forming device and the above-described sheet feeding device. The image forming device is configured to form an image on a recording medium. The sheet feeding device is configured to feed the recording medium to the image forming device.

### BRIEF DESCRIPTION OF THE SEVERAL VIEWS OF THE DRAWINGS

An exemplary embodiment of this disclosure will be described in detail based on the following figured, wherein:

FIG. 1 is a schematic diagram illustrating an image forming apparatus according to an embodiment of this disclosure;

FIG. 2 is a cross-sectional view illustrating a sheet feed tray unit of a sheet feeding device according to an embodiment of this disclosure;

FIG. 3 is a cross-sectional view illustrating a main part of the sheet feeding device according to an embodiment of this disclosure;

FIG. 4 is a perspective view illustrating a schematic configuration of the main part of the sheet feeding device according to an embodiment of this disclosure;

FIG. 5 is an enlarged perspective view illustrating the main part of the sheet feeding device of FIG. 4;

FIG. 6 is a perspective view illustrating a schematic configuration of a fixed guide cover used in the sheet feeding device according to an embodiment of this disclosure;

FIG. 7 is a schematic view illustrating a regulator used in the sheet feeding device according to an embodiment of this disclosure;

FIG. 8 is a perspective view illustrating a schematic configuration of the fixed guide cover and the regulator used in the sheet feeding device according to an embodiment of this disclosure;

FIG. 9A is a plan view illustrating the schematic configuration of the main part of the sheet feeding device according to an embodiment of this disclosure;

FIG. 9B is a side view illustrating the schematic configuration of the main part of the sheet feeding device according to an embodiment of this disclosure;

FIG. 10 is a schematic diagram illustrating movement of a pressure plate used in the sheet feeding device according to an embodiment of this disclosure; and

FIG. 11 is a schematic diagram illustrating another pressure plate used in the sheet feeding device according to an embodiment of this disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

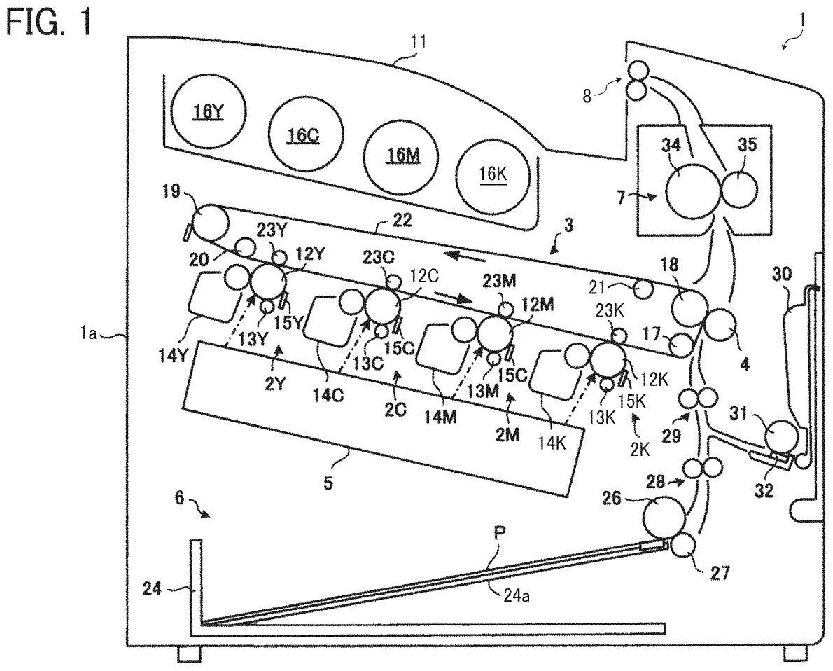

FIG. 1 is schematic diagram illustrating an image forming apparatus 1 according to an embodiment of this disclosure. In FIG. 1, the image forming apparatus 1 is a color printer. Note that, in other embodiments, the image forming apparatus is not limited to a color printer but may be a monochrome printer or another type of image forming apparatus such as a copier or a multifunction peripheral. The image forming apparatus 1 includes a housing la that includes four image forming units 2Y, 2C, 2M, and 2K, a primary transfer unit 3, a secondary transfer roller 4, an optical writing device 5, a sheet feeding device 6 that functions as a target recording medium sheet feeder, a fixing device 7, a pair of sheet ejection rollers 8, and a sheet ejection tray 11.

The image forming units 2Y, 2C, 2M, and 2K are disposed at substantially a center of the housing la. The image forming units 2Y, 2C, 2M, and 2K correspond to yellow image, cyan image, magenta image, and black image, respectively, and include respective photoconductor drums 12Y, 12C, 12M, and 12K, each of which functions as an image bearer. Further, the image forming units 2Y, 2C, 2M, and 2K include charging rollers 13Y, 13C, 13M, and 13K, developing devices 14Y, 14C, 14M, and 14K, and photoconductor cleaning devices 15Y, 15C, 15M, and 15K, respectively. It is to be noted that the image forming units 2Y, 2C, 2M, and 2K are occasionally referred to as the “image forming unit 2” in a single form without suffixes. Similarly, the charging rollers 13Y, 13C, 13M, and 13K, the developing devices 14Y, 14C, 14M, and 14K, and the photoconductor cleaning devices 15Y, 15C, 15M, and 15K are also occasionally referred to as the “charging roller 13”, the “developing device 14”, and the “photoconductor cleaning device 15”, respectively, in a singular form. The optical writing device 5 emits light to irradiate a surface of the photoconductor drum 12 (i.e., the photoconductor drums 12Y, 12C, 12M, and 12K), so that an electrostatic latent image that corresponds to the image is formed on the surface of the photoconductor drum 12. Toner is supplied from a toner bottle 16 (i.e., toner bottles 16Y, 16C, 16M, and 16K) to the developing device 14 (i.e., the developing devices 14Y, 14C, 14M, and 14K) to develop the electrostatic latent image into a visible toner image.

The primary transfer unit 3 is disposed above the image forming unit 2. The primary transfer unit 3 includes an entrance roller 17, a drive roller 18, an opposing roller 19, a backup roller 20, a support roller 21, and a transfer belt 22 stretched over these rollers. The primary transfer unit 3 further includes primary transfer rollers 23Y, 2 5 23C, 23M, and 23K. The primary transfer rollers 23Y, 23C, 23M, and 23K are disposed facing the photoconductor drums 12Y, 12C, 12M, and 12K, respectively, via the transfer belt 22. The single toner images having respective colors of yellow, cyan, magenta, and black formed on the photoconductor drums 12Y, 12C, 12M, and 12K are sequentially overlaid on the surface of the transfer belt 22.

The secondary transfer roller 4 is disposed at a position facing the drive roller 18 via the transfer belt 22. A bias applying unit applies a bias to the secondary transfer roller 4. By so doing, the secondary transfer roller 4 transfers the composite toner image formed on the surface of the transfer belt 22, collectively onto a sheet P that is fed from the sheet feeding device 6.

The optical writing device 5 is disposed below the image forming unit 2. The optical writing device 5 has a known configuration including a light source, a polygon mirror, various mirrors and lenses. The optical writing device 5 forms an electrostatic latent image corresponding to an image input from an external device such as a personal computer onto the surface of the photoconductor drum 12.

The sheet feeding device 6 is disposed in a lower part of the housing la and includes a sheet tray 24, a sheet feed roller 26, and a sheet separation roller 27. The sheet tray 24 includes a bottom plate 24a that functions as a sheet loader that loads a sheet P that functions as a sheet-shaped recording medium. The sheet feed roller 26 functions as a sheet feeding body to feed out the sheet P form the sheet tray 24. The sheet separation roller 27 functions as a sheet separating body to separate and convey the sheet P together with the sheet feed roller 26. The sheet feeding device 6 further includes a pair of sheet conveying rollers 28, a pair of registration rollers 29, a bypass tray 30, a secondary sheet feed roller 31, and a friction pad 32. The secondary sheet feed roller 31 feeds the sheet P from the bypass tray 30. The friction pad 32 separates the sheet P and conveys the sheet P together with the secondary sheet feed roller 31.

The sheet tray 24 that is located at the lowest part of the housing la is pulled out to the right in FIG. 1 when a cover that is supported by the housing 1a to open and close relative to the housing 1a is opened. The bottom plate 24a is attached to the sheet tray 24 to be vertically movable. A plurality of sheets P is loaded on an upper face of the bottom plate 24a. The sheet feed roller 26 is disposed above the bottom plate 24a to contact with an uppermost sheet P on top of the plurality of sheets P loaded on the bottom plate 24a. The sheet feed roller 26 is driven by a drive unit to rotate in a counterclockwise direction in FIG. 1. The sheet separation roller 27 has a material with high friction resistance, such as rubber, around the circumferential surface. The circumferential surface, such as rubber, of the sheet separation roller 27 is pressed against a circumferential surface of the sheet feed roller 26 by a biasing body. Details of the biasing body are described below.

The pair of sheet conveying rollers 28 includes a drive roller and a driven roller. Both the drive roller and the driven roller are rotatably supported by the housing 1a. The drive roller of the pair of sheet conveying rollers 28 is driven by a drive unit to rotate, thereby rotating the driven roller that is pressed against the drive roller, to convey the sheet P. The pair of registration rollers 29 is disposed downstream from the pair of sheet conveying rollers 28 in a sheet conveyance direction. The pair of registration rollers 29 includes a drive roller and a driven roller. The drive roller of the pair of registration rollers 29 is also driven to rotate by a drive unit to convey the sheet P toward a downstream side in the sheet conveyance direction at a given timing.

The bypass tray 30 is supported by the cover to open and close relative to the cover. Sheets are loaded on the bypass tray 30 when the bypass tray 30 is open. The secondary sheet feed roller 31 is also supported by the cover to open and close relative to the cover. The secondary sheet feed roller 31 separates and feeds the sheet P loaded on the bypass tray 30, one by one, cooperating with the friction pad 32. It is to be noted that the cover also rotatably supports the secondary transfer roller 4 and a pressure roller 35. When the cover is to open, a sheet conveyance passage emerges to allow the sheet P to pass through.

The fixing device 7 is disposed downstream from the secondary transfer roller 4 in the sheet conveyance direction. The fixing device 7 includes a heat roller 34 and a pressure roller 35 and is disposed at the upper part of the housing la. The heat roller 34 includes a heater inside and is rotatably supported by the housing la. The heat roller 34 is rotated by a drive unit. The pressure roller 35 is rotatably supported by the cover. A biasing force applied by a biasing body causes the circumferential surface of the pressure roller 35 to closely contact and press against a circumferential surface of the heat roller 34, so that the pressure roller 35 is rotated along with rotation of the heat roller 34. The toner image formed on the surface of the sheet P that passes between the heat roller 34 and the pressure roller 35 is fixed to the sheet P by application of heat and pressure.

The pair of sheet ejection rollers 8 is disposed downstream from the fixing device 7 in the sheet conveyance direction. The pair of sheet ejection rollers 8 includes a drive roller and a driven roller. As the drive roller of the pair of sheet ejection rollers 8 is rotated by a drive unit, the driven roller is rotated along with the rotation of the drive roller, so that the sheet P is ejected to the outside of the housing la. After having been ejected by the pair of sheet ejection rollers 8, the sheet P is ejected to and stacked in the sheet ejection tray 11 that is an integral part of the upper face of the housing 1a.

According to the above-described configuration, the sheet P loaded on the bottom plate 24a is held between (gripped by) a pad 24b and the sheet feed roller 26 for image formation to the sheet P. By so doing, when two or more sheets P are conveyed, the two or more sheets P are conveyed to the downstream side in the sheet conveyance direction and are separated one by one between the sheet feed roller 26 and the sheet separation roller 27, so that only a single sheet P at a time is further conveyed. Consequently, the sheet P that has been separated and fed from the sheet tray 24 is conveyed by the pair of sheet conveying rollers 28 and the pair of registration rollers 29. Then, the toner image is transferred onto the sheet P by the secondary transfer roller 4. The sheet P having the toner image then passes through the fixing device 7. When passing through the fixing device 7, the toner image is fixed to the sheet P. Then, the sheet P is guided to the pair of sheet ejection rollers 8 to be ejected to the sheet ejection tray 11.

Similar to a known sheet feeding device, the sheet feeding device 6 of the image forming apparatus 1 has a configuration designed to eliminate an increase in frequent occurrence of multi-sheet feeding failure of the sheets P when the sheets P are added to the sheet tray 24. To be more specific, insertion of additional sheets P reduces a friction force generated between the sheets P at a position of insertion of the additional sheets or additional sheet bundle. When the friction force generated at the sheet adding position falls below a friction force generated at another position between other sheets, a few sheets before the sheet adding position are not separated reliably. Consequently, the sheet P is separated from the sheet adding position, resulting in a multi-sheet feeding failure involving a bundle of sheets. In order to separate the sheets P to feed the sheets P one by one reliably, a constant friction force is applied between the sheets P and the lower sheet P remains without being conveyed together with the upper sheet P when the upper sheet P is being fed.

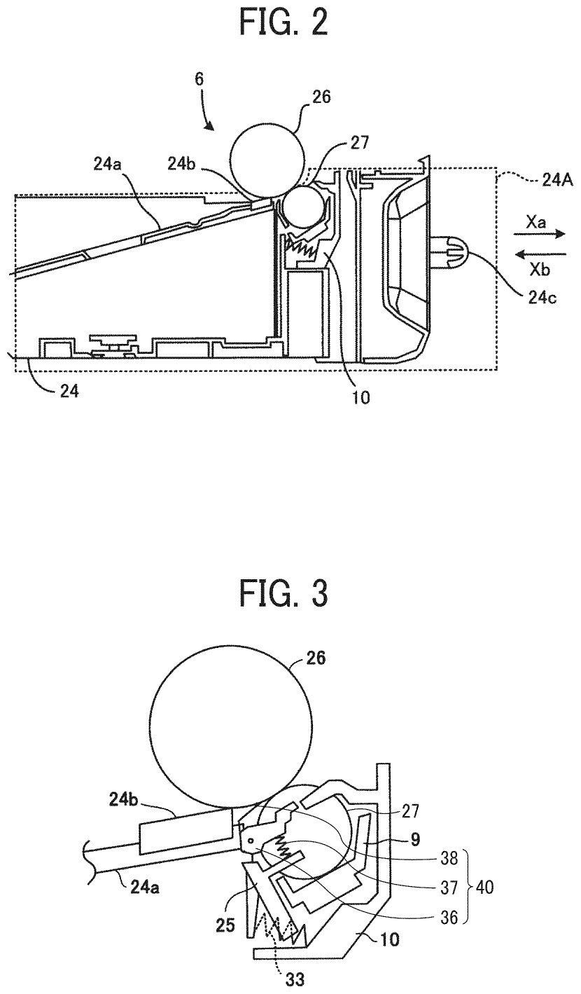

FIG. 2 is a cross-sectional view illustrating a sheet feed tray unit 24A of the sheet feeding device 6 according to an embodiment of this disclosure. FIG. 2 illustrates a state in which the sheet feed tray unit 24A is inserted and set to the housing 1a.

The sheet feed tray unit 24A includes the sheet tray 24, the bottom plate 24a, the pad 24b, and the sheet separation roller 27, as indicated by a broken line in FIG. 2. The sheet feed tray unit 24A includes (a pair of) rotary bodies 36, compression springs 37, and a pressure plate 38 (see FIG. 3). The (pair of) rotary bodies 36, the compression springs 37, and the pressure plate 38 compose a regulator 40 that functions as a pre-separation pressure mechanism illustrated in FIGS. 3 and 7.

When the cover that is openably closable and supported relative to the housing 1a is opened, the sheet feed tray unit 24A is pulled in a tray removal direction Xa (that is, to the right in FIG. 2) so as to additionally supply the sheet P or sheets P. Further, the sheet feed tray unit 24A is configured to be inserted in a tray insertion direction Xb (that is, to the left in FIG. 2) after the additional sheets P are supplied.

In order to additionally supply the sheets P, a user holds a handle 24c that functions as an integrally formed part with the sheet tray 24, pulls out the sheet feed tray unit 24A in the tray removal direction Xa, and loads the sheets P onto the bottom plate 24a from above of FIG. 3. Thereafter, insertion of the sheet feed tray unit 24A to the state illustrated in FIG. 1 completes preparation for separating and conveying the sheets P one by one as described above.

FIG. 3 is a cross-sectional view illustrating a main part of the sheet feeding device 6 according to an embodiment of this disclosure.

In FIG. 3, the sheet feed roller 26 is rotatably supported by the housing la and is driven by a drive unit to rotate in a counterclockwise direction in FIG. 3. When the sheet feed tray unit 24A illustrated in FIG. 2 has been inserted in the tray insertion direction Xb (that is, to the left in FIG. 2) and completely set to the housing la, the sheet feed roller 26 comes to contact the sheet separation roller 27.

The pad 24b is disposed at a tip of the bottom plate 24a. The pad 24b includes a high friction resistance member to prevent a multi-sheet feeding failure of the sheets P. The pad 24b prevents the sheet bundle of sheets P from being excessively fed or causes the force for feeding the sheets P to be sufficiently transmitted.

The bottom plate 24a is lifted by a sheet feed pressure spring so that a force is applied to move the bottom plate 24a in an upward direction in FIG. 3. The sheet loaded on the bottom plate 24a is pressed against the sheet feed roller 26 by the force of the sheet feed pressure spring, and then obtains a force to convey the sheet to the subsequent process.

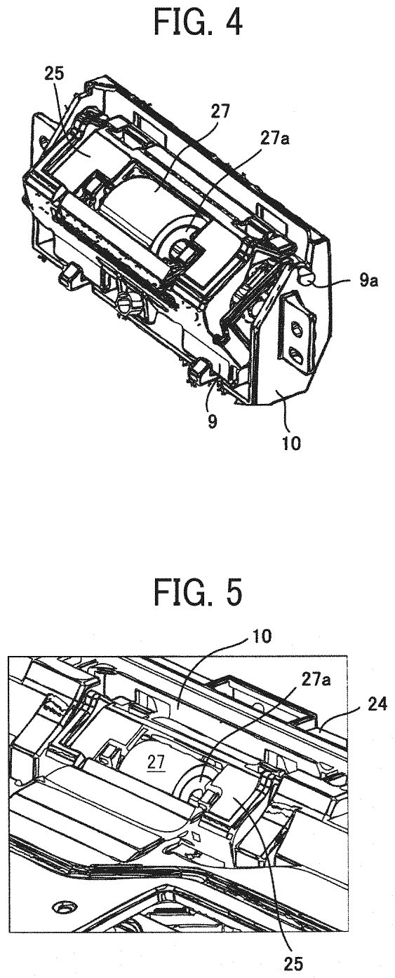

FIG. 4 is a perspective view illustrating a schematic configuration of the main part of the sheet feeding device 6 according to an embodiment of this disclosure. FIG. 5 is an enlarged perspective view illustrating the main part of the sheet feeding device 6 of FIG. 4. The sheet separation roller 27 is disposed below the sheet feed roller 26. The width of the sheet separation roller 27 is smaller than the width of the sheet feed roller 26. It is to be noted that the width of the sheet separation roller 27 may be equal to the width of the sheet feed roller 26 or greater.

As illustrated in FIGS. 2 to 5, the sheet separation roller 27 is rotatably supported by a movable bracket 9. A fixed base 10 is fixedly mounted on the sheet tray 24. As illustrated in FIG. 4, the movable bracket 9 is rotatably supported by the fixed base 10 at a fulcrum 9a. In other words, the movable bracket 9 has the fulcrum 9a that is rotatably supported by the fixed base 10 to swing (rotate) about the fulcrum 9a within a given angle range in clockwise and counterclockwise directions in FIG. 4.

A compression spring 33 is interposed between the movable bracket 9 and the fixed base 10. The compression spring 33 applies a biasing force to the movable bracket 9 in a direction in which the sheet separation roller 27 is pressed against the sheet feed roller 26. The biasing force of the compression spring 33 causes the sheet separation roller 27 to be pressed against the sheet feed roller 26, so that the sheet separation roller 27 closely contacts the sheet feed roller 26 to form a region through which the sheets are conveyed to be separated. As described above, the movable bracket 9, the sheet separation roller 27, and the compression spring 33 compose the pressure pre-separation mechanism.

As illustrated in FIG. 5, a torque limiter 27a is provided coaxially with the sheet separation roller 27 so that the torque limiter 27a is built inside the sheet separation roller 27. According to the torque limiter 27a, the sheet separation roller 27 idles when the excessive torque is generated. With this configuration, a region that has been occupied by a torque limiter in the configuration of a known sheet feeding device may be used as an open space. Accordingly, the open space made by reducing the length of the support shaft of the sheet separation roller 27 may be used to provide other parts or to reduce the size of a device, that is, the pre-separation pressure mechanism including the pair of rotary bodies 36, the compression springs 37, and the pressure plate 38.

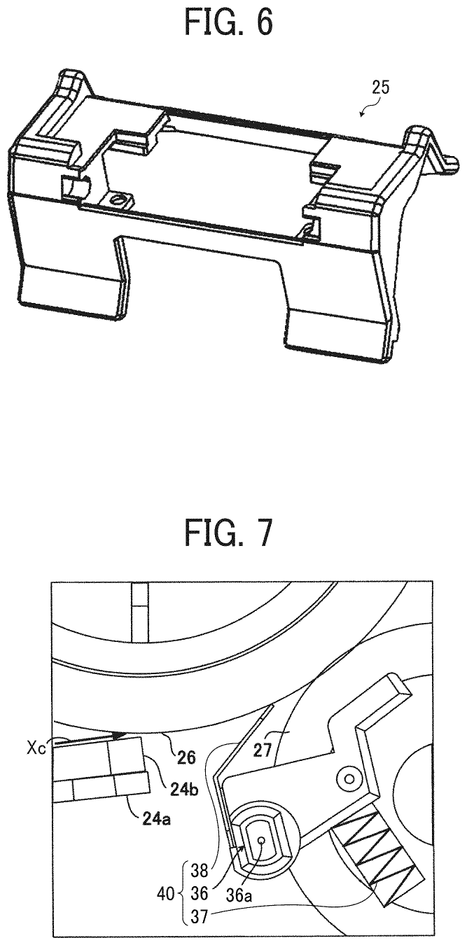

FIG. 6 is a perspective view illustrating a schematic configuration of a fixed guide cover 25 in the sheet feeding device 6 according to an embodiment of this disclosure. The fixed guide cover 25 functions as a support and is disposed above the sheet separation roller 27.

The fixed guide cover 25 is disposed so that the sheet P passes over the upper surface of the fixed guide cover 25. The fixed guide cover 25 is arranged to cover the support shaft of the sheet separation roller 27 and has an upper face to guide the sheet P to be conveyed along the upper face.

As illustrated in FIG. 6, the fixed guide cover 25 has an opening through which the circumferential surface of the sheet separation roller 27 is exposed. The fixed guide cover 25 is detachably attached to the fixed base 10 with screws or engaging members.

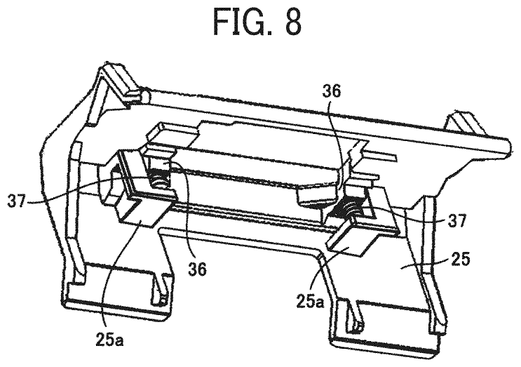

FIG. 7 is a schematic view illustrating the regulator 40 of the sheet feeding device 6 according to an embodiment of this disclosure. FIG. 8 is a perspective view illustrating a schematic configuration of the fixed guide cover 25 and the regulator 40 in the sheet feeding device 6 according to an embodiment of this disclosure. As illustrated in FIGS. 7 and 8, the pair of rotary bodies 36 is disposed inside the fixed guide cover 25 and the respective rollers of the pair of rotary bodies 36 are located at respective positions outside support positions of the sheet separation roller 27. It is to be noted that, hereinafter, for convenience, the pair of rotary bodies 36 and the compression springs 37 are occasionally referred to in the singular form, for example, the “rotary body 36” and the “compression spring 37.”

The rotary body 36 is rotatably supported by the fixed guide cover 25 on a support shaft 36a. The compression spring 37 functions as a biasing body and is mounted on the rotary body 36, at a position downstream from the support shaft 36a in the sheet conveyance direction Xc. One end of the compression spring 37 is fixed to the projection 25a of the fixed guide cover 25.

A pressure plate 38 is disposed at an upstream side end of each of the pair of rotary bodies 36 in the sheet conveyance direction Xc. The pressure plate 38 functions as a plate-shaped pressing member formed by pressing and blanking and includes a metal material such as stainless steel. The pressure plate 38 is attached to the pair of rotary body 36 by a double tape and glues. The rotary body 36 is biased by the biasing force of the compression spring 37 to rotate about the support shaft 36a in the counterclockwise direction in FIG. 7. According to this configuration, the edge of the pressure plate 38 is pressed with a given contact pressure against the circumferential surface of the sheet feed roller 26 at a position downstream from the support shaft 36a in the sheet conveyance direction Xc. The pressure plate 38 is configured to swing (rotate) about the support shaft 36a together with the rotary body 36 within a given movable angle range of the rotary body 36 in clockwise and counterclockwise directions in FIG. 7.

As illustrated in FIG. 8, the compression springs 37 are configured to be attached at two places, one compression spring 37 on the left side and the other compression spring 37 on the right side, of the sheet separation roller 27 disposed at the center of the sheet feeding device 6. As illustrated in FIG. 5, by providing the torque limiter 27a provided inside the roller part of the sheet separation roller 27, the open space is effectively used to press the sheet separation roller 27 in a well-balanced manner.

In a case in which the pressure plate 38 is a thin metal plate, the pressure plate 38 has good strength even if the plate is thin, and therefore the metal plate is inserted between the sheet feed roller 26 and the sheet separation roller 27 without damaging the edge of the metal plate. In addition, the pressure plate 38 is excellent in contact durability with sheets, and therefore achieves a maintenance-free configuration having a long service life.

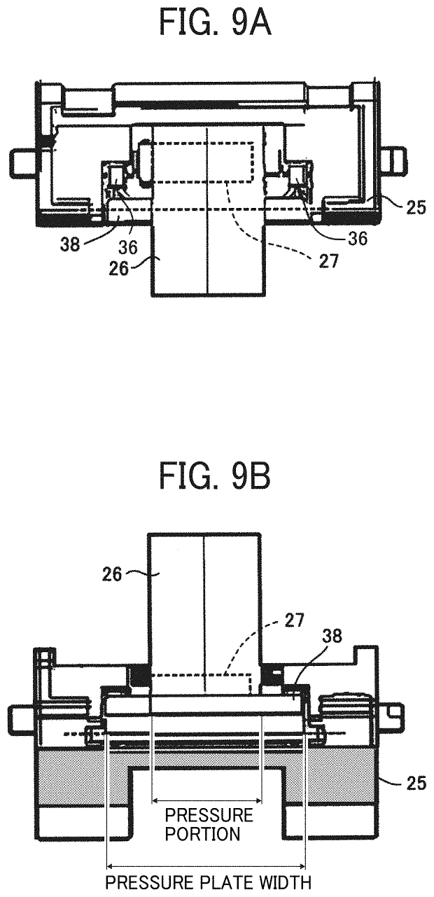

FIG. 9A is a plan view illustrating the schematic configuration of the main part of the sheet feeding device 6 according to an embodiment of this disclosure. FIG. 9B is a side view illustrating the schematic configuration of the main part of the sheet feeding device 6 according to an embodiment of this disclosure, viewed from the sheet tray 24 of the sheet feeding device 6.

As illustrated in FIGS. 9A and 9B, the pressure plate width, in other words, the length of the sheet width direction of the pressure plate 38 in a sheet width direction perpendicular to the sheet conveyance direction Xc is greater than the width of the sheet feed roller 26. As described above, the pressure plate 38 is pressed against the sheet feed roller 26 and is in pressure contact. The pressure contact portion of the pressure plate 38 is also referred to as a pressure portion.

Similar to a pressing member (that is, a pressure plate) of a known sheet feeding device, the pressure plate 38 keeps the sheet P straight since the pressure plate 38 supports the sheet P even in an area beyond the width of the sheet feed roller 26. Consequently, when multiple sheets P enter between the sheet feed roller 26 and the sheet separation roller 27, the multiple sheets P remain straight in a stable condition. Accordingly, a frictional state between any adjacent sheets P in the multiple sheets is stabilized, and therefore the sheets P are separated reliably. In other words, by increasing the pressure plate width of the pressure plate 38 in the sheet width direction to be wider (greater) than the width of the pressure portion, sheet behavior is stabilized to provide good separation.

As described above, in the sheet feeding device 6 according to this disclosure, the edge of the pressure plate 38 contacts and separates from the circumferential surface of the sheet feed roller 26. According to this configuration, the multiple sheets P are conveyed between the sheet feed roller 26 and the sheet separation roller 27. At this position, when the multiple sheets P pass through the pressure portion that is the pressure contact portion of the pressure plate 38, a lower sheet P of the multiple sheets P contacts a sloped face of the pressure plate 38. Due to the contact with the sloped face of the pressure plate 38, the lower sheet P receives a sheet conveyance load (resistance), which prevents the lower sheet P from climbing over the pressure plate 38. Consequently, the upper sheet P alone of the multiple sheets P is conveyed to the sheet separation roller 27. According to the above-described operation, sheet separation is performed in two steps, thereby conveying the sheet P without causing a multi-sheet feeding error even if any additional sheet is inserted to the sheet tray.

FIG. 10 is a schematic diagram illustrating movement of the pressure plate 38 used in the sheet feeding device 6 according to an embodiment of this disclosure.

Each of the pair of rotary bodies 36 is supported by the fixed guide cover 25 at the support position that is the position of the support shaft 36a. The support position is located upstream from the contact position of the pressure plate 38 and the sheet feed roller 26 in the sheet conveyance direction Xc.

With this configuration, as illustrated in FIG. 10, even when the multiple sheets P enter the contact position between the pressure plate 38 and the sheet feed roller 26, the pressure plate 38 rotates together with the rotary body 36 in the clockwise direction, as indicated by arrow in FIG. 10, against the biasing force of the compression spring 37. Accordingly, since the pressure plate 38 moves to the downstream side in the sheet conveyance direction Xc to avoid the multiple sheets, a paper jam is prevented.

Known sheet feeding devices have a configuration including a fixed separation plate and another sheet pressing mechanism to press the upper side of a sheet. However, since this known configuration does not include a movable separation plate, a thick paper could not be conveyed or a rubber employed to a sheet separation roller was scraped, and therefore the durability was unstable. A comparative configuration includes a fixed guide cover that functions as a supporting member having such a separation plate. The fixed guide cover 25 according to this disclosure achieves the above-described effect by attaching to the fixed base 10 instead of a fixed guide cover provided to the comparative configuration. Accordingly, the effect of this disclosure is obtained easily without changing the comparative configuration significantly.

Further, while a pickup roller is provided to the comparative configuration, the sheet feeding device 6 according to an embodiment of this disclosure employs a pickup less mechanism that does not include a pickup roller. Therefore, even without a pressing mechanism, the sheet feeding device 6 achieves the separation performance at low cost.

It is to be noted that, in the sheet feed tray unit 24A including the regulator 40 (see FIG. 2), the rotary body 36 illustrated in FIG. 7 is rotatable about of the support shaft 36a within a given angle range. In FIG. 2, a stopper mechanism is provided to prevent the pressure plate 38 from contacting the sheet feed roller 26. With the stopper mechanism, when the sheet feed tray unit 24A is pulled out in the tray removal direction Xa, the pressure plate 38 and the rotary body 36 are restricted from rotating excessively in the counterclockwise direction by the biasing force of the compression spring 37. Further, a rotary body retaining mechanism is provided to prevent the rotary body 36 from coming off from the fixed guide cover 25 due to excessive rotation.

Further, when the sheet feed tray unit 24A is inserted in the opposite direction, 3 0 in other words, when the sheet feed tray unit 24A is inserted intentionally in the tray insertion direction Xb as illustrated in FIG. 2, the pressure plate 38 and the sheet separation roller 27 contact the sheet feed roller 26 excessively. In order to prevent this excessive contact with the sheet feed roller 26, a rotation restricting mechanism is provided to the sheet feeding device 6.

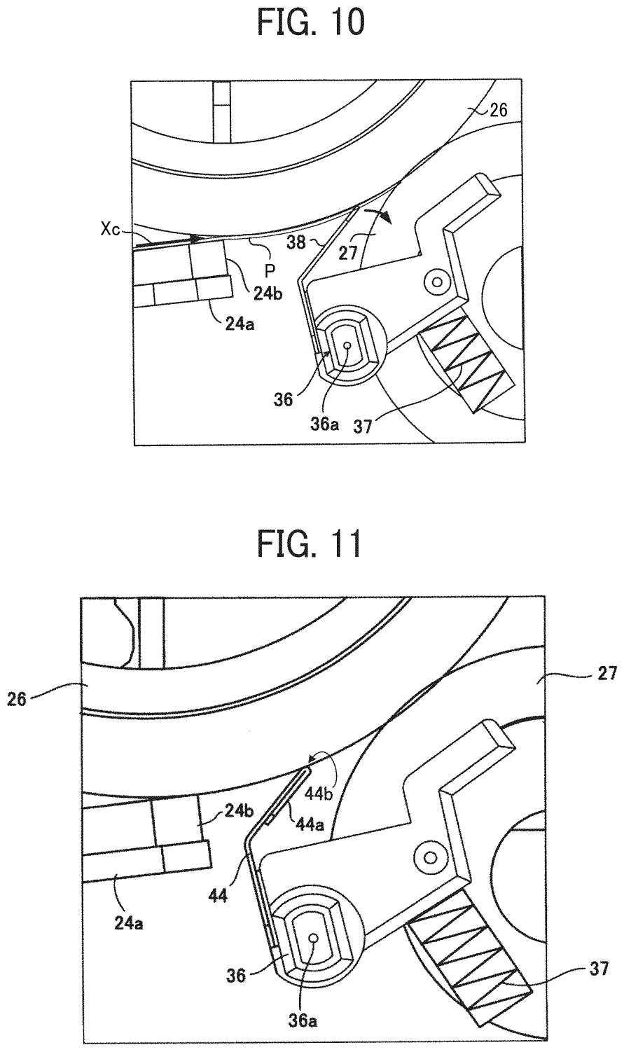

FIG. 11 is a schematic diagram illustrating a pressure plate 44 that is another pressure plate used in the sheet feeding device 6 according to an embodiment of this disclosure.

The structure of the pressure plate 44 illustrated in FIG. 11 is basically identical to the structure of the pressure plate 38 illustrated in FIG. 7, except that the pressure plate 44 of FIG. 11 includes a folded portion 44a at the edge. The folded portion 44a of the pressure plate 44 indicates a bending edge formed by folding a flat metal plate. The edge of the pressure plate 44 includes a part of the folded portion 44a on the side that contacts with the sheet feed roller 26. The pressure plate 38 and the pressure plate 44 are identical to each other in structure, where the pressure plate 38 and the pressure plate 44 are processed by pressing and blanking a stainless steel plate, for example. The folded portion 44a is formed by deforming (folding) the edge of the pressure plate 44 into an R-shape portion 44b. More specifically, the folded portion 44a is formed by folding the folded portion 44a at an angle of approximately 180 degrees. In other words, the folded portion 44a is formed by the hemming (folding).

With respect to the pressure plate 44 illustrated in FIG. 11, the folded portion 44a is stronger, less damaging to a sheet P to contact due to a round-shaped (R-shaped) portion of the folded portion 44a, and lengthens a distance to the sheet separation roller 27 due to no projection of the folded portion 44a to the sheet separation roller 27. According to this configuration, it is less likely that the pressure plate 44 contacts the sheet separation roller 27, and therefore the configuration prevents the sheet separation roller 27 from being damaged by the pressure plate 44.

The sheet P to be conveyed does not directly contact the pressed end face of the pressure plate 38 (which indicates the end face in the thickness direction of the outer peripheral shape of the pressure plate 38 in FIG. 7) and the pressed end face of the pressure plate 44 (which indicates the end face in the thickness direction of the outer peripheral shape of the pressure plate 44 in FIG. 11). However, if rust occurs due to, for example, a change over time, it is likely that the rust is exposed on the sheet conveyance passage, which may be a major factor that hinders conveyance of the sheet.

Further, unless some sort of processing is performed, the surfaces of the steel plate (for example, stainless steel plate) of the pressure plate 38 and the pressure plate 44 remain in the initial state of the steel plate. Since the sheet P is conveyed while the surface of the sheet P contacts the surfaces of the steel plate of the pressure plate 38 and the pressure plate 44, the condition (coefficient of friction) of the surface of the steel plate is not controlled in this state. The obstructing force against the sheet moving force changes depending on the coefficient of friction of the steel plate surfaces of the pressure plate 38 and the pressure plate 44 with respect to the sheet P and the sheet feed roller 26, which greatly affects the function of sheet conveyance while separating the sheet P.

In order to address this inconvenience, in one embodiment of this disclosure, the pressure plate 38 and the pressure plate 44, both of which function as metallic pressing members, are metal-plated after pressing and blanking the surface that contacts or faces at least the sheet P and the sheet feed roller 26.

By performing the metal plating on the surfaces of the pressure plates 38 and 44 as described above, rust due to the change of time is prevented from occurring, in particular, at the edges formed by pressing and blanking and, at the same time, the coefficient of friction is changed according to the separation characteristics. Since the metal-plated surface does not affect adhesion for fixing the pressure plates 38 and 44, the entire configuration is maintained as in the case without metal plating.

If the hemming is not performed, the punched edges of the pressure plates 38 and 44 are exposed in a direction perpendicular to the sheet conveyance passage. Occurrence of rust without the hemming is more affected than when the hemming is performed. Even in such a case without the hemming, the above-described metal plating is performed to restrain occurrence of rust, so that the above-mentioned concern may be eliminated.

For example, in a case in which electroplated bright nickel plating is performed as a specific metal plating onto the pressure plates 38 and 44 that are formed by pressing an electrolytic zinc-plated metal steel plate, the coefficient of friction of the steel plate, which is a base material of the pressure plates 38 and 44, to the sheet feed roller 26 including rubber material is changed by approximately 10 percent (%) from 1.8 to 1.6.

According to the classification by a film formation mechanism, any method may be used for performing the above-described metal plating process. Examples of the method include electroplating, hot-dip plating, and electroless plating. In particular, since hot-dip plating (in other words, immersion dipping) is a process in which a steel material is immersed in a molten metal and is plated, the entire surfaces of the pressure plates 38 and 44 to be metal-plated (including the punched edges formed by pressing) are plated with a thick film in a short time. With this method, the entire surfaces of the pressure plates 38 and 44, including the areas contacting or facing the sheet P, are formed with a metal plating film easily.

In addition, according to the classification by apparatus and process, any method may be employed for performing the above-described metal plating process. Examples of the method include rack plating, barrel plating, and hoop plating.

The above-described metal plating is performed after forming the shapes of members and components such as the pressure plates 38 and 44. “Forming the shapes of members and components” refers to cutting, bending, or both. This process achieves an effect of protecting the cut surface forming the part and an effect of retaining a stable surface property when compared with the bending after the processing. In other words, the metal plates are formed on the surfaces of the pressure plates 38 and 44, at least on the surface shaped (cut, bent, or both) as a part that contacts or faces the sheet P and the sheet feed roller 26.

As described above, the configuration according to an embodiment of this disclosure achieves basic effects, which are to prevent the rust of the pressing member from occurring and to change the friction coefficient of the pressing member to the sheet as the recording medium.

The above-described embodiments are illustrative and do not limit this disclosure. Thus, numerous additional modifications and variations are possible in light of the above teachings. For example, elements and/or features of different illustrative embodiments may be combined with each other and/or substituted for each other within the scope of this disclosure.

The sheet feeding device according to this disclosure includes a pressing member made of metal, for example, the pressure plate 38 illustrated in FIG. 7 and the pressure plate 44 illustrated in FIG. 11. However, the pressing member applicable to this disclosure is not limited to the pressure plate 38 and the pressure plate 44. For example, pressure plates employed in a comparative sheet feeding device may be applied to this disclosure. To be more specific, a pressure plate in the comparative sheet feeding device is a stainless steel plate that includes a folded portion at the edge. The folded portion is formed by bending the leading end of the pressure plate at an angle of substantially 90 degrees toward a direction opposite to a sheet feed roller of the comparative sheet feeding device. Another pressure plate of the comparative sheet feeding device includes a folded portion and has a structure simpler than the above-described pressure plate. Different from the above-described pressure plate, the bending of this pressure plate begins at a portion closer to the root. Yet another pressure plate of the comparative sheet feeding device also includes a folded portion and has a round shape at the edge. These pressure plates of the comparative sheet feeding device may be applied to this disclosure.

Here, an additional description is given of the above-described comparative sheet feeding device. The comparative sheet feeding device includes the configurations in which the above-described pressure plates are used as pressing members made of metal plates to separate and convey a sheet functioning as a cording target medium. The comparative sheet feeding device has the configuration similar to the configuration of the sheet feeding device 6 according to an embodiment of this disclosure, in that a pressing member of made of a metal plate is employed.

However, the comparative sheet feeding device cannot prevent occurrence of rust on the pressing member, and therefore the coefficient of friction of the pressing member to a recording medium cannot change.

As described above, this disclosure is applicable to the sheet feeding device 6 having the configuration illustrated in FIGS. 1 and 7 and the sheet feeding device 6 having the configuration employing the sheet feed roller, the sheet separation roller, and the pressing member of the comparative sheet feeding device. However, the configuration applicable to this disclosure is not limited to the above-described configurations. For example, this disclosure may be applicable to another configuration of the comparative sheet feeding device including a pickup roller, a sheet feed roller, and a pressing member and yet another configuration of the comparative sheet feeding device including a sheet feed roller, a friction pad, and a pressing member.

In the above-described embodiments, the term “image forming apparatus” indicates an apparatus in which an image is formed on a recording medium such as paper, OHP (overhead projector) transparencies, OHP film sheet, thread, fiber, fabric, leather, metal, plastic, glass, wood, and/or ceramic by attracting developer or ink thereto; the term “image formation” indicates an action for providing (i.e., printing) not only an image having meanings such as texts and figures on a recording medium but also an image having no meaning such as patterns on a recording medium; and the term “sheet” is not limited to indicate a paper material but also includes the above-described plastic material (e.g., an OHP sheet), a fabric sheet and so forth, and is used to which the developer or ink is attracted. In addition, the “sheet” is not limited to a flexible sheet but is applicable to a rigid plate-shaped sheet and a relatively thick sheet.

Further, the size (dimension), material, shape, and relative positions used to describe each of the components and units are examples, and the scope of this disclosure is not limited thereto unless otherwise specified. Further, it is to be noted in the following examples that: the term “sheet conveying direction” indicates a direction in which a recording medium travels from an upstream side of a sheet conveying path to a downstream side thereof; the term “width direction” indicates a direction basically perpendicular to the sheet conveying direction.

It is to be noted that reference sign “X” indicates is a direction from the front 2 0 side to the rear side of the image forming apparatus 1, reference sign “Y” indicates is a direction from the left side to the right side of the image forming apparatus 1, and reference sign “Z” indicates is a direction perpendicular to the direction X and the direction Y. In the above-described embodiments, the sheet P for image formation is employed as a recording medium on which an image is formed. However, the sheet P is not limited to the recording medium but also includes thick paper, postcard, envelope, plain paper, thin paper, coated paper, art paper, tracing paper, and the like. The sheet P further includes a non-paper material such as OHP sheet, OHP film, resin film, and any other sheet-shaped material on which an image may be formed.

The effects described in the embodiments of this disclosure are listed as the examples of preferable effects derived from this disclosure, and therefore are not intended to limit to the embodiments of this disclosure.

The embodiments described above are presented as examples to implement this disclosure and are not intended to limit the scope of this disclosure. These novel embodiments can be implemented in various other forms, and various omissions, replacements, or changes can be made without departing from the gist of this disclosure. These embodiments and their variations are included in the scope and gist of this disclosure, and are included in the scope of this disclosure recited in the claims and its equivalent.

What is claimed is:

1. A sheet feeding device for an image forming apparatus, comprising:
a sheet feeding body configured to feed a recording medium;
a sheet separating body configured to separate the recording medium and convey the recording medium together with the sheet feeding body;
a loading body configured to load the recording medium to be fed by the sheet feeding body;
a support disposed above the sheet separating body; and
a pressing body made of metal and rotatably supported by the support between the loading body and the sheet separating body,
the pressing body being configured to contact and separate with respect to the sheet feeding body at an edge of the pressing body,
the pressing body including a part-shaped face to contact or face the recording medium, a surface of the part being covered with a metal plating.

2. The sheet feeding device according to claim 1, further comprising:
a rotary body rotatably supported by the support; and
a biasing body configured to bias the rotary body,
wherein the pressing body is attached to the rotary body, and
the pressing body is configured to press the sheet feeding body at the edge of the pressing body.

3. The sheet feeding device according to claim 1,
wherein the pressing body has a width greater than a width of the sheet feeding body in a direction perpendicular to a direction in which the sheet feeding body feeds the recording medium.

4. The sheet feeding device according to claim 1,
wherein the pressing body includes a folded portion at the edge of the pressing body.

5. The sheet feeding device according to claim 4,
wherein the folded portion is a rounded part of the edge of the pressing body.

6. The sheet feeding device according to claim 5,
wherein the folded portion is a part of the edge of the pressing body folded back at an angle of 180 degrees.

7. An image forming apparatus comprising:
an image forming device configured to form an image on a recording medium; and
the sheet feeding device according to claim 1, configured to feed the recording medium to the image forming device.
